(19) United States
(12) Patent Application Publication
(10) Pub. No.: US 2026/0336357 A1
(43) Pub. Date: Oct. 29, 2026

(54) FAN SHROUD SYSTEM WITH COOLANT PLUMBING AND INTEGRATED HARDWARE

(71) Applicant: GM Global Technology Operations LLC, Detroit, MI (US)

(72) Inventors: Christopher K. Clarke, Commerce, MI (US); Nathanael Drew Osborn, Plymouth, MI (US)

(73) Assignee: GM Global Technology Operations LLC, Detroit, MI (US)

(21) Appl. No.: 19/187,026

(22) Filed: Apr. 23, 2025

(51) Int. Cl. B60H 1/00

(52) U.S. Cl. CPC B60H 1/00464; B60H 1/00428

(57) ABSTRACT

A cooling system for a vehicle includes a fan shroud system having a shroud including a quick-connect receptacle, an electric fan disposed in the shroud, and a fluid conduit disposed in the shroud and communicatively coupled to the quick-connect receptacle. The cooling system further including a low-temperature radiator (LTR) arranged on and communicatively coupled to the fan shroud system via the quick-connect receptacle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to vehicles and, more particularly, to cooling systems for vehicles.

Vehicles are commonly equipped with various cooling systems to assist with thermal regulation of an engine as well as other components that produce heat during operation. Radiators have been used to help dissipate heat from engine coolant into the surrounding environment. Fan shrouds have also been relied on to help direct airflow at the radiator to enhance cooling efficiency. Arranging a radiator with respect to a fan shroud can be difficult due to spatial constraints and the need to optimize airflow paths. Shortcomings of existing systems and methods will be addressed by one or more aspects of the present disclosure.

### SUMMARY

In one configuration, a cooling system for a vehicle is provided and includes a fan shroud system having a shroud including a quick-connect receptacle, an electric fan disposed in the shroud, and a fluid conduit disposed in the shroud and communicatively coupled to the quick-connect receptacle. The cooling system further including a low-temperature radiator (LTR) arranged on and communicatively coupled to the fan shroud system via the quick-connect receptacle.

The cooling system may include one or more of the following optional aspects. For example, the quick-connect receptacle can be integrally formed with the shroud. The quick-connect receptacle can include a passage extending between an inlet and an outlet. The fluid conduit can be communicatively coupled to the outlet of the quick-connect receptacle. The cooling system can further include a coupler that is communicatively coupled to the LTR and communicatively coupled to the inlet of the quick-connect receptacle. The coupler can be integrally formed with the LTR.

According to at least one aspect, the LTR includes an inlet and an outlet spaced from the inlet. The cooling system can further include a coupler including a first end having a nipple that corresponds with the inlet of the quick-connect receptacle and a second end spaced from the first end and directly coupled to the outlet of the LTR.

According to another aspect, the fluid conduit includes a first inlet, a second inlet, and an outlet. The second inlet can be directly connected to the quick-connect receptacle.

In another configuration, a vehicle is provided and includes a vehicle body extending between a first end and a second end spaced from the first end, the vehicle body including a hood and a grille that defines an engine bay at the first end. The vehicle further includes a cooling system having a fan shroud system arranged adjacent to the grille within the engine bay. The fan shroud system further including a shroud having a front side and a rear side spaced from the front side, the shroud including a quick-connect receptacle arranged at one of a first side or a second side that each extend between the front side and the second side, an electric fan disposed within the shroud between the front side and the rear side, and a fluid circulant system arranged on the shroud and communicatively coupled to the quick-connect receptacle. The cooling system further including a low temperature radiator (LTR) coupled to the rear side of the shroud and communicatively coupled to the quick-connect receptacle.

The vehicle may include one or more of the following optional aspects. For example, the fluid circulant system can include a fluid conduit that is at least partially disposed within the shroud. The fluid conduit can be communicatively coupled to the quick-connect receptacle. The fluid circulant system can include a refillable coolant tank communicatively coupled to the fluid conduit and arranged upstream of the quick-connect receptacle. The fluid circulant system includes a pump arranged downstream of the quick-connect receptacle.

According to at least one aspect, the quick-connect receptacle can be integrally formed with the shroud. The quick-connect receptacle can include a passage that has an inlet and an outlet. The cooling system can further include a coupler having a first end arranged in the inlet of the passage and a second end communicatively coupled to the LTR. The LTR includes an outlet that can be directly coupled to the second end of the coupler. The coupler can be integrally formed with the outlet of the LTR.

### BRIEF DESCRIPTION OF THE DRAWINGS

The drawings described herein are for illustrative purposes only of selected configurations and are not intended to limit the scope of the present disclosure.

FIG. 1 is a side view of a vehicle according to principles of the present disclosure;

FIG. 2 is a front perspective view of one configuration of a fan shroud system according to the principles of the present disclosure;

FIG. 3 is a cross-sectional view of the fan shroud system of FIG. 2;

FIG. 4 is a front view of another configuration of a fan shroud system according to the principles of the present disclosure;

FIG. 5 is a rear view of the fan shroud system of FIG. 4;

FIG. 6 is a side view of the fan shroud system of FIG. 4; and FIG. 7 is a close-up cross-sectional view of the fan shroud of FIG. 4 along Line 7-7 of FIG. 4.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Existing cooling systems rely on push pins, zip ties, and protective sleeves that consume space and can be difficult to manipulate within an engine bay or another region of a vehicle. According to at least some aspects of the present disclosure, a cooling system is provided that reduces the number of components necessary for communicatively coupling a low-temperature radiator and a fluid conduit arranged on a fan shroud. In doing so, the cooling system discussed in more detail below reduces potential leak paths and reduces the overall packaging footprint.

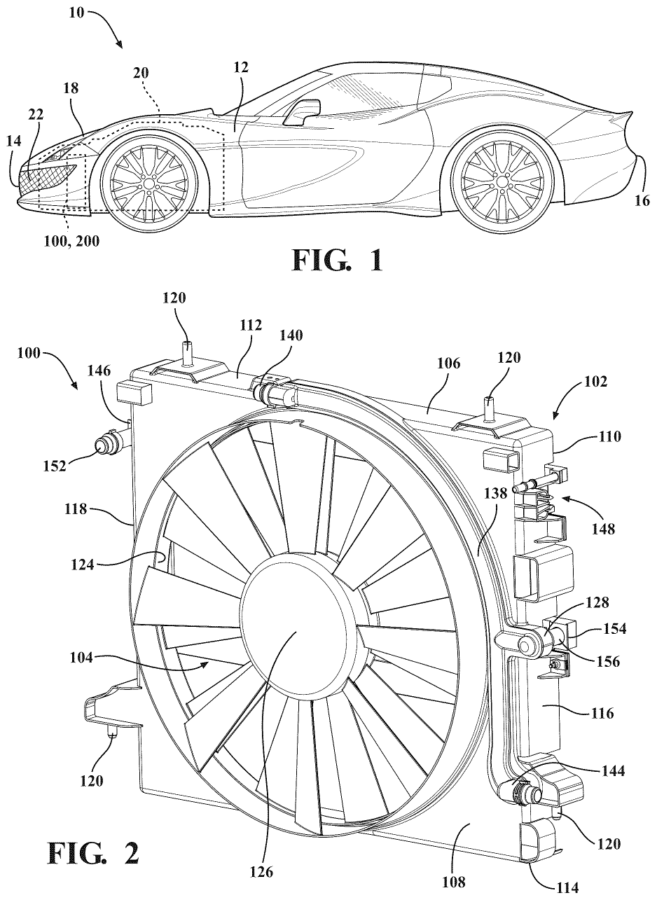

With reference to FIG. 1, an illustrative example of a vehicle 10 is provided. The vehicle 10 has a vehicle body 12 extending between a first end 14 and a second end 16. The vehicle body 12 includes a hood 18 that encloses an engine bay 20. A radiator grille 22 can be arranged at the first end 14 of the vehicle body 12 and can be configured to allow air to flow into the engine bay 20 during and after operation. A cooling system 100 can be positioned in the engine bay 20 adjacent to the radiator grille 22 and configured to utilize airflow through the radiator grille 22 or another inlet in the vehicle body 12 for cooling.

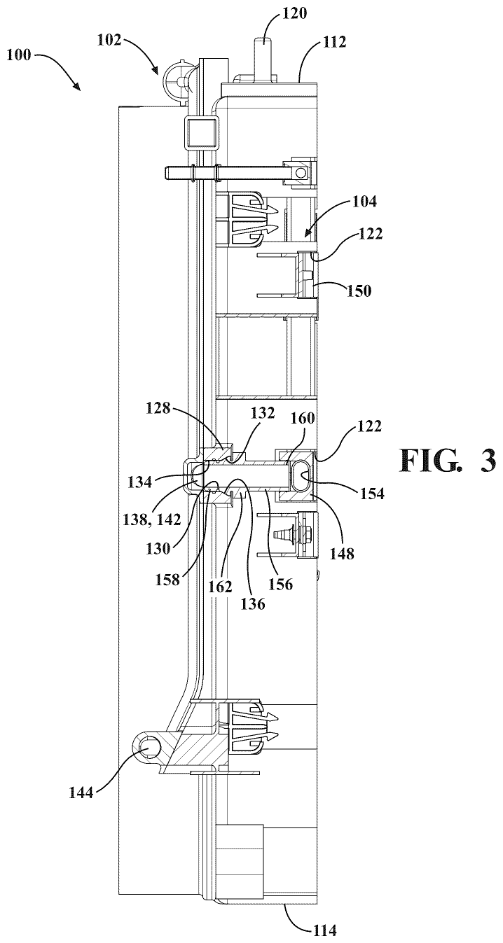

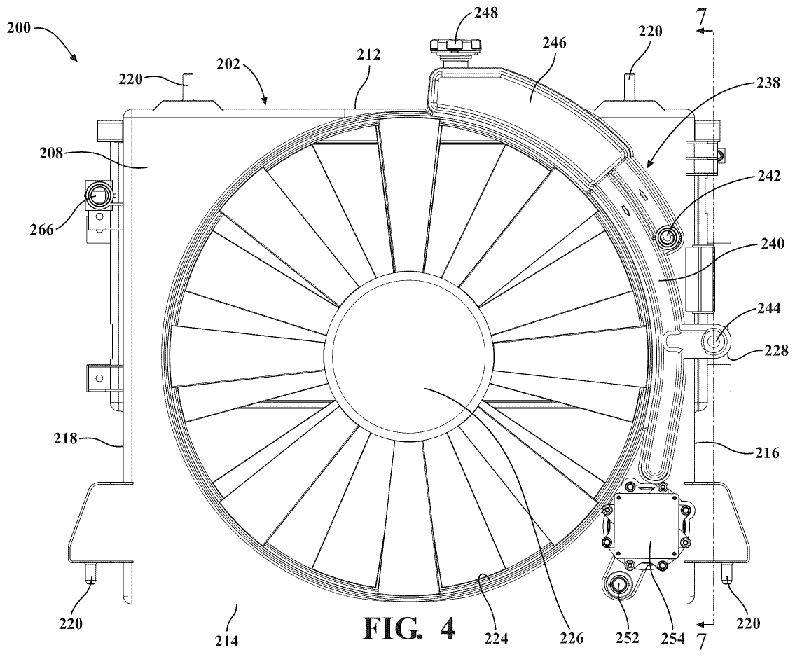

With reference to FIGS. 2 and 3, an illustrative example of a cooling system 100 for a vehicle is provided. The cooling system 100 can be used in the vehicle 10 introduced above or in another vehicle, such as a tractor or another non-automotive example. The cooling system 100 includes a fan shroud system 102 and a low-temperature radiator (LTR) 104.

The fan shroud system 102 includes a shroud 106 that has a front side 108 and a rear side 110 spaced from the front side 108, an upper end 112 and a lower end 114 spaced from upper end 112, and a right side 116 and a left side 118 spaced from the right side 116. The shroud 106 can include one or more pins or locating features 120 that correspond with portions of the vehicle body 12 and can be desirable for installing the cooling system 100 within the vehicle 10, for example. Additionally, the shroud 106 can include one or more slots 122 extending through portions of the upper end 112, the lower end 114, the left side 118, and/or the right side 116 that are configured to receive and retain a portion of the LTR 104. This can be desirable so that the LTR 104 can be quickly installed on the shroud 106 during assembly, for example. The shroud 106 includes a central opening 124 that extends from the front side 108 through the rear side 110 and receives an electric fan 126. The electric fan 126 can be controlled to help thermally regulate (e.g., enhance cooling) the LTR 104, for example.

The shroud 106 further includes a quick-connect receptacle 128 coupled to or otherwise attached to the shroud 106 between the front side 108 and the rear side 110. In the present example, the quick-connect receptacle 128 is integrally coupled to and extends from the right side 116 of the shroud 106. In other words, the quick-connect receptacle 128 can be welded to the shroud 106 or formed via powder bed fusion with the rest of the shroud 106. Other methods commonly used in the automotive industry can also be used so that the quick-connect receptacle 128 is an integral component of the shroud 106. However, the quick-connect receptacle 128 can be configured in another location on the shroud 106 as well. The quick-connect receptacle 128 is desirable so that the LTR 104 can be quickly communicatively coupled to the shroud 106 during assembly of the cooling system 100, for example.

With reference to FIG. 3, the quick-connect receptacle 128 includes a passage 130 that has an inlet 132 and an outlet 134 spaced from the inlet 132. The inlet 132 can include a wall 136 that tapers in a direction toward the outlet 134. In doing so, as discussed in more detail below, the quick-connect receptacle 128 can easily receive a coupler so that the LTR 104 can be communicatively coupled to the shroud 106.

With reference again to FIG. 2, the fan shroud system 102 includes a fluid conduit 138 that has one or more inlets and one or more outlets for carrying a fluid between the one or more inlets and the one or more outlets. In the present illustrative example, the fluid conduit 138 is at least partially disposed within the shroud 106 and includes a first inlet 140 adjacent to the upper end 112 of the shroud 106 and a second inlet 142 communicatively coupled to the quick-connect receptacle 128. Additionally, the fluid conduit 138 includes an outlet 144 arranged downstream of both the first inlet 140 and the second inlet 142.

With continued reference to FIGS. 2 and 3, the LTR 104 includes a first end 146 adjacent to the left side 118 of the shroud 106 and a second end 148 adjacent to the right side 116 of the shroud 106. The LTR 104 includes one or more hooks or flanges 150 extending from the first end 146 and the second end 148 that correspond with the one or more slots 122 of the shroud 106. The flanges 150 allow the LTR 104 to be quickly arranged on the shroud 106 during assembly, for example. The LTR 104 can include one or more inlets and one or more outlets spaced from the one or more inlets. The LTR 104 can be configured to receive a fluid via the one or more inlets and remove heat from the fluid as the fluid travels toward the one or more outlets. In the present illustrative example, the LTR 104 includes an inlet 152 arranged at the first end 146 and an outlet 154 arranged at the second end 148. The outlet 154 is coupled to the fluid conduit 138 of the fan shroud system 102 via the quick-connect receptacle 128. More particularly, with reference to FIG. 3, a coupler 156 can be communicatively coupled to the outlet 154 of the LTR 104 that allows for quick and efficient connection between the LTR 104 and the shroud 106 during assembly. The coupler 156 includes a first end 158 and a second end 160 spaced from the first end 158. The first end 158 can include a tapered nipple 162 that corresponds with the wall 136 of the passage 130 of the quick-connect receptacle 128. The second end 160 can be coupled to or otherwise attached to the outlet 154 of the LTR 104. According to at least one aspect, the coupler 156 is integrally formed with the outlet 154 of the LTR 104.

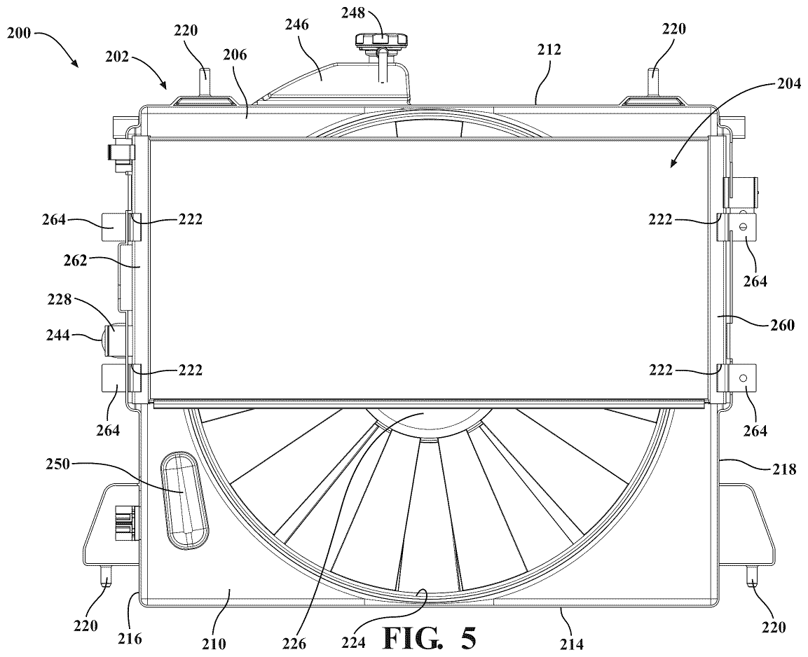

FIGS. 4-7 illustrate another illustrative configuration of a cooling system 200 for a vehicle. This configuration is similar in many respects to the configuration of FIGS. 1-3. Accordingly, the descriptions of the configurations are hereby incorporated into one another, and description of subject matter common to the configurations generally may not be repeated.

With reference to FIGS. 4-7, the cooling system 200 can be used in the vehicle 10 introduced above or in another vehicle, such as a tractor or another non-automotive example. The cooling system 200 includes a fan shroud system 202 and a low-temperature radiator (LTR) 204.

The fan shroud system 202 includes a shroud 206 that has a front side 208 and a rear side 210 spaced from the front side 208, an upper end 212 and a lower end 214 spaced from upper end 212, and a right side 216 and a left side 218 spaced from the right side 216. The shroud 206 can include one or more pins or locating features 220 that correspond with portions of the vehicle body 12 and can be desirable for installing the cooling system 200 within the vehicle 10, for example. Additionally, the shroud 206 can include one or more slots 222 extending through portions of the upper end 212, the lower end 214, the left side 218, and or the right side 216 that are configured to receive and retain a portion of the LTR 204. This can be desirable so that the LTR 204 can be quickly installed on the shroud 206 during assembly, for example. The shroud 206 includes a central opening 224 that extends from the front side 208 through the rear side 210 and receives an electric fan 226. The electric fan 226 can be controlled to help thermally regulate (e.g., enhance cooling) the LTR 204, for example.

The shroud 206 further includes a quick-connect receptacle 228 coupled to or otherwise attached to the shroud 206 between the front side 208 and the rear side 210. In the present example, the quick-connect receptacle 228 is integrally coupled to and extends from the right side 216 of the shroud 206. In other words, the quick-connect receptacle 228 can be welded to the shroud 206 or formed via powder bed fusion with the rest of the shroud 206. Other methods commonly used in the automotive industry can also be used so that the quick-connect receptacle 228 is an integral component of the shroud 206. However, the quick-connect receptacle 228 can be configured in another location on the shroud 206 as well. The quick-connect receptacle 228 is desirable so that the LTR 204 can be quickly communicatively coupled to the shroud 206 during assembly of the cooling system 200, for example.

With reference to FIG. 7, the quick-connect receptacle 228 includes a passage 230 that has an inlet 232 and an outlet 234 spaced from the inlet 232. The inlet 232 can include a wall 236 that tapers in a direction toward the outlet 234. In doing so, as discussed in more detail below, quick-connect receptacle 228 can easily receive a coupler so that the LTR 204 can be communicatively coupled to the shroud 206.

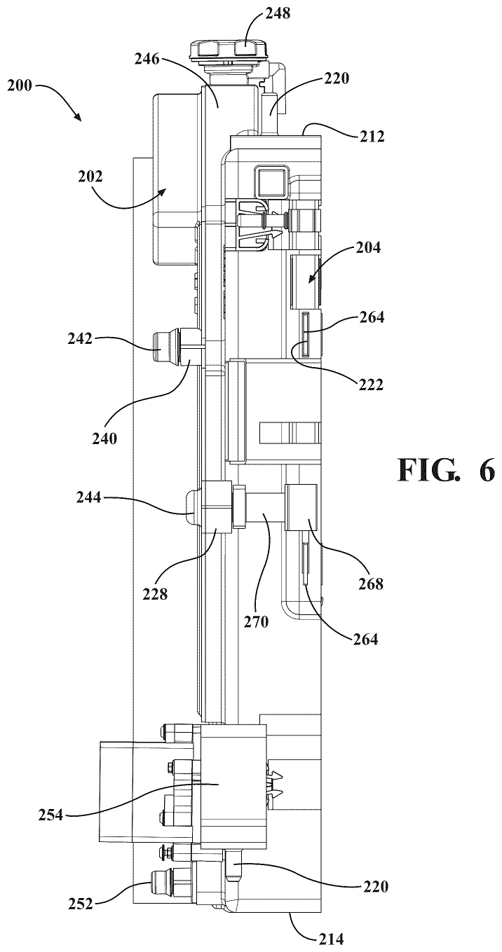

With reference again to FIG. 4, the fan shroud system 202 includes a fluid circulant system 238 arranged on the shroud 206 and communicatively coupled to the quick-connect receptacle 228. The fluid conduit 240 can have one or more inlets and one or more outlets for carrying a fluid between the one or more inlets and the one or more outlets. In the present illustrative example, the fluid conduit 240 is at least partially disposed within the shroud 206 and includes a first inlet 242 and a second inlet 244 that are both arranged adjacent to the right side 216 of the shroud 206. In the present example, the second inlet 244 is communicatively coupled to the outlet 234 of the quick-connect receptacle 228. Optionally, the fluid circulant system 238 can include a refillable tank 246 arranged downstream of the first inlet 242 and upstream of the quick-connect receptacle 228 and the second inlet 244. The refillable tank 246 includes a cap 248 that can be removed so that fluid can be replenished during a maintenance event, for example. With reference to FIG. 5, the fluid conduit 240 can include a channel 250 arranged downstream of the quick-connect receptacle 228 and second inlet 244 and positioned on the rear side 210 of the shroud 206. The channel 250 can be configured to direct fluid toward an outlet 252 of the fluid conduit 240. Optionally, the fluid circulant system 238 can include a pump 254 arranged downstream of the quick-connect receptacle 228 but upstream of the outlet 252 of the fluid conduit 240. More particularly, the pump 254 can be arranged downstream of the channel 250 but upstream of the outlet 252 of the fluid conduit 240. The pump 254 can be configured to move fluid to another region within the engine bay 20, for example.

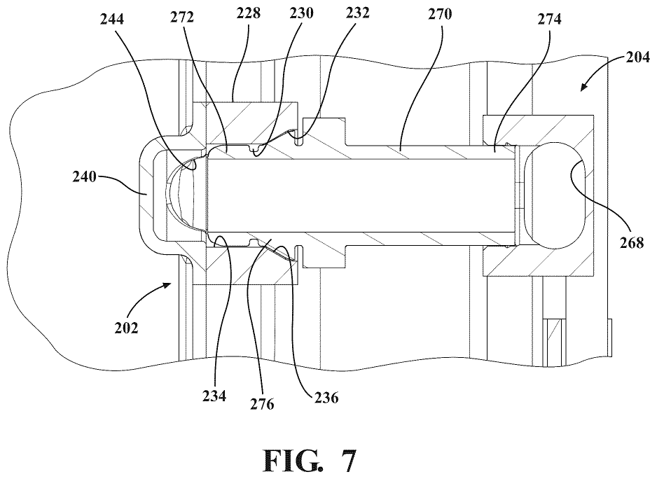

With continued reference to FIGS. 5 and 6, the LTR 204 includes a first end 260 adjacent to the left side 218 of the shroud 206 and a second end 262 adjacent to the right side 216 of the shroud 206. The LTR 204 includes one or more hooks or flanges 264 extending from the first end 260 and the second end 262 that correspond with the one or more slots 222 of the shroud 206. The flanges 264 allow the LTR 204 to be quickly arranged on the shroud 206 during assembly, for example. The LTR 204 can include one or more inlets and one or more outlets spaced from the one or more inlets. The LTR 204 can be configured to receive a fluid via the one or more inlets and remove heat from the fluid as the fluid travels toward the one or more outlets. In the present illustrative example, the LTR 204 includes an inlet 266 arranged at the first end 260 and an outlet 268 arranged at the second end 262. The outlet 268 of the LTR 204 is coupled to the fluid conduit 240 of the fluid circulant system 238 via the quick-connect receptacle 228. More particularly, with reference to FIG. 7, a coupler 270 can be communicatively coupled to the outlet 268 of the LTR 204 that allows for quick and efficient connection between the LTR 204 and the shroud 206 during assembly. The coupler 270 includes a first end 272 and a second end 274 spaced from the first end 272. The first end 272 of the coupler 270 can include a tapered nipple 276 that corresponds with the wall 236 of the passage 230 of the quick-connect receptacle 228. The second end 274 of the coupler 270 can be coupled to or otherwise attached to the outlet 268 of the LTR 204. According to at least one aspect, the coupler 270 is integrally formed with the outlet 268 of the LTR 204.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A cooling system for a vehicle, comprising:
a fan shroud system, comprising:
a shroud including a quick-connect receptacle,
an electric fan disposed in the shroud, and
a fluid conduit disposed in the shroud and communicatively coupled to the quick-connect receptacle; and
a low-temperature radiator (LTR) arranged on and communicatively coupled to the fan shroud system via the quick-connect receptacle.

2. The cooling system of claim 1, wherein the quick-connect receptacle is integrally formed with the shroud.

3. The cooling system of claim 2, wherein the quick-connect receptacle includes a passage extending between an inlet and an outlet.

4. The cooling system of claim 3, wherein the fluid conduit is communicatively coupled to the outlet of the quick-connect receptacle.

5. The cooling system of claim 4, further including a coupler that is communicatively coupled to the LTR and communicatively coupled to the inlet of the quick-connect receptacle.

6. The cooling system of claim 5, wherein the coupler is integrally formed with the LTR.

7. The cooling system of claim 3, wherein the LTR includes an inlet and an outlet spaced from the inlet.

8. The cooling system of claim 7, further comprising a coupler including a first end having a nipple that corresponds with the inlet of the quick-connect receptacle and a second end spaced from the first end and directly coupled to the outlet of the LTR.

9. The cooling system of claim 2, wherein the fluid conduit includes a first inlet, a second inlet, and an outlet.

10. The cooling system of claim 9, wherein the second inlet is directly connected to the quick-connect receptacle.

11. A vehicle, comprising:
a vehicle body extending between a first end and a second end spaced from the first end, the vehicle body includes a hood and a grille that defines an engine bay at the first end;
a cooling system, comprising:
a fan shroud system arranged adjacent to the grille within the engine bay, the fan shroud system comprising:
a shroud including a front side and a rear side spaced from the front side, the shroud including a quick-connect receptacle arranged at one of a first side or a second side that each extend between the front side and the second side,
an electric fan disposed within the shroud between the front side and the rear side, and
a fluid circulant system arranged on the shroud and communicatively coupled to the quick-connect receptacle; and
a low temperature radiator (LTR) coupled to the rear side of the shroud and communicatively coupled to the quick-connect receptacle.

12. The vehicle of claim 11, wherein the fluid circulant system includes a fluid conduit that is at least partially disposed within the shroud.

13. The vehicle of claim 12, wherein the fluid conduit is communicatively coupled to the quick-connect receptacle.

14. The vehicle of claim 13, wherein the fluid circulant system includes a refillable coolant tank communicatively coupled to the fluid conduit and arranged upstream of the quick-connect receptacle.

15. The vehicle of claim 14, wherein the fluid circulant system includes a pump arranged downstream of the quick-connect receptacle.

16. The vehicle of claim 11, wherein the quick-connect receptacle is integrally formed with the shroud.

17. The vehicle of claim 16, wherein the quick-connect receptacle includes a passage that has an inlet and an outlet.

18. The vehicle of claim 17, further including a coupler having a first end arranged in the inlet of the passage and a second end communicatively coupled to the LTR.

19. The vehicle of claim 18, wherein the LTR includes an outlet that is directly coupled to the second end of the coupler.

20. The vehicle of claim 18, wherein the coupler is integrally formed with the outlet of the LTR.
